(19) United States
(12) Patent Application Publication
(10) Pub. No.: US 2004/0206142 A1
(43) Pub. Date: Oct. 21, 2004

(54) Tumbler corrosion protection apparatus and method

(76) Inventors: Lucas J. Boesel, Milwaukee, WI (US); Christopher R. Last, Milwaukee, WI (US)

Correspondence Address: MICHAEL BEST & FRIEDRICH, LLP, 100 E WISCONSIN AVENUE, MILWAUKEE, WI, 53202, US

(21) Appl. No.: 10/418,177

(22) Filed: Apr. 17, 2003

(51) Int. Cl. E05B 15/16; E05B 29/04

(52) U.S. Cl. 70/417; 70/492

(57) ABSTRACT

The lock according to some embodiments of the present invention has a housing, a cylinder disposed within the housing, and a tumbler received within the cylinder. The tumbler can be movable between a first position in which the tumbler directly or indirectly engages the housing to restrict rotation of the cylinder with respect to the housing, and a second position in which the cylinder is rotatable with respect to the housing. In some embodiments, the tumbler can be biased toward the first position. A key can be inserted into the cylinder to actuate the tumbler from the first position to the second position. Once the tumblers are disengaged from the housing, the cylinder can rotate with respect to the housing. The tumblers are made from aluminum to reduce corrosion between the tumblers and the zinc cylinder.

### FIELD OF THE INVENTION

This invention relates generally to locks and locking methods, and more particularly to locks and locking methods employing cylinder locks having one or more tumblers.

### BACKGROUND OF THE INVENTION

Locks are commonly used for security purposes to prevent access into a vehicle, through a closure member, or into a secured space. Many lock assemblies include one or more tumblers movable by insertion of a properly-coded key in order to place the lock assembly in an unlocked state. By way of example only, some lock assemblies employ a housing, a cylinder disposed within the housing, and tumblers received within the cylinder to selectively secure the cylinder against rotation with respect to the housing. In some cases, the tumblers engage the housing to restrict rotation of the cylinder with respect to the housing. A properly-coded key inserted into the cylinder disengages the tumblers from the housing. The tumblers can be biased toward engagement with the cylinder, thereby normally placing the lock in a locked state (when no properly coded key is inserted into the cylinder). Once the tumblers are disengaged from the housing, the cylinder can rotate with respect to the housing to actuate a connected latch or other element or device.

Locks commonly experience corrosion, such as galvanic corrosion or oxidation, that causes the lock to seize or fail. Galvanic corrosion occurs between dissimilar metals when such metals contact one another. One metal acts as an anode and the other metal acts as a cathode, causing electrons to be transferred from the anode to the cathode. In locks, galvanic corrosion generally occurs because of causes internal with the lock. Oxidation occurs when a single metal is exposed to outside elements, such as moisture or salt. Therefore, in locks, oxidation generally occurs because of causes external from the lock.

In some conventional lock mechanisms, lock cylinders are made at least partially from zinc, while the tumbler(s) and key are made from brass. The brass tumblers generally contact the zinc cylinder, facilitating galvanic corrosion between the tumblers and the cylinder. The zinc acts as an anode and the brass acts as a cathode. Corrosion within the lock between the tumblers and cylinder limits the useful life of the lock.

In addition to the considerations above regarding resistance to corrosion, tumblers employed in tumbler locks typically meet strength, durability, and wear-resistance standards in order to insure satisfactory lock life.

In light of the problems and limitations of the prior art described above, a lock mechanism which helps reduce lock failure and corrosion within the lock would be a welcome addition to the art.

### SUMMARY OF THE INVENTION

Some embodiments of the lock according to the present invention provide improved corrosion protection between components of the lock mechanism. Such corrosion protection helps lengthen the useful life of the lock. In some embodiments, the lock includes a housing, a cylinder disposed within the housing, and a tumbler at least partially received within the cylinder. The tumbler can be movable between a first position in which the tumbler restricts rotation of the cylinder with respect to the housing, and a second position in which the cylinder is rotatable with respect to the housing. In some embodiments, the cylinder is made from a first material that is more anodic than brass, and the tumbler is made from a second material that is also more anodic than brass but less anodic than the first material. The second material can also have a Rockwell B hardness of between about 75 and about 95.

Although other materials can be used, in some embodiments, the first material is zinc, and the second material is aluminum. Zinc is more anodic than brass. Aluminum is also more anodic than brass, but is less anodic than zinc. Heat treated aluminum alloy 7075-T6 is an example of a type of aluminum that falls within the hardness range mentioned above for the second material. Since the second material is more anodic than brass, galvanic corrosion is reduced between the cylinder and the tumbler. In some cases, the second material has a density less than 0.2 lb/in³ to help reduce the weight of the lock.

More information and a better understanding of the present invention can be achieved by reference to the following drawings and detailed description.

### BRIEF DESCRIPTION OF THE DRAWINGS

The present invention is further described with reference to the accompanying drawings, which show an embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a perspective exploded assembly view of a lock mechanism according to an exemplary embodiment of the present invention.

References below to directions (such as left, right, up, down, top, bottom, front, rear, back etc.) in describing the drawings are made relative to the drawings (as normally viewed) for convenience only. These directions are not intended as a limitation upon the orientation and arrangement of any part or assembly of the present invention, nor do they limit the present invention in any form.

### DETAILED DESCRIPTION

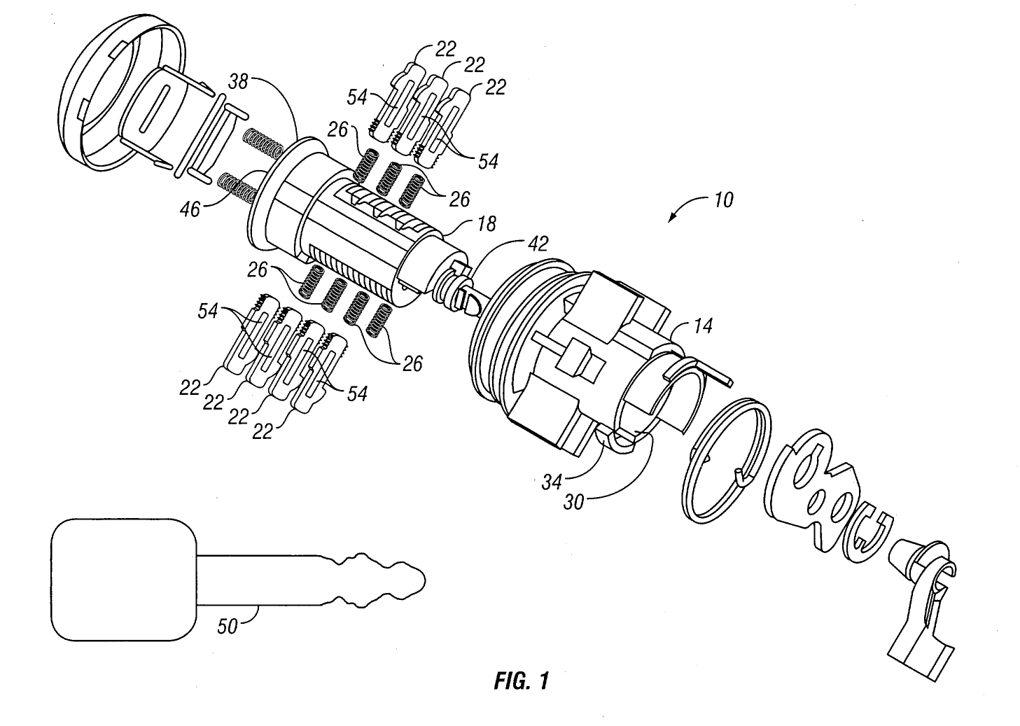

FIG. 1 illustrates a mechanical lock assembly 10 according to an exemplary embodiment of the present invention. This exemplary lock assembly 10 has a housing 14, a cylinder 18, and a set of tumblers 22, and can be used in any application in which a lock assembly is needed to secure one element or structure with respect to another or to enable or disable a device. By way of example only, the lock assembly 10 in the illustrated embodiment is employed for vehicular applications, such as to selectively lock or unlock latches for closure members (e.g., doors, trunks, or other similar closure devices and elements). In the illustrated embodiment, the tumblers 22 are at least partially received within the cylinder 18, and the cylinder 18 is at least partially disposed within the housing 14. The tumbler 22 is movable with respect to the housing 14 between a first position in which the tumbler 22 directly (see FIG. 1) or indirectly restricts rotation of the cylinder 18 with respect to the housing 14, and a second position in which the cylinder 18 is rotatable with respect to the housing 14.

In the illustrated embodiment, the lock assembly 10 includes multiple tumblers 22 at least partially received within the cylinder 18. The number, configuration, and arrangement of the tumblers 22 received within the cylinder 18 can vary for the lock assembly 10. In some embodiments, the tumblers 22 are biased toward a locked position to restrict rotation of the cylinder 18 with respect to the housing 14. Tumbler springs 26 or other biasing elements can be positioned to bias the tumblers 22 toward their locked positions.

The housing 14 can be connected to any structure desired, such as a vehicle door or trunk lid. Although any housing shape can be employed, the illustrated housing 14 has a substantially cylindrical shape and includes an inner surface 30. In some embodiments, the housing 14 has one or more recesses, holes, grooves, or other apertures in which the tumblers 22 are movable to restrict cylinder rotation in the locked state of the lock assembly 10. In the illustrated embodiment for example, the housing 14 includes two channels 34 located opposite one another along the inner surface 30. When the tumblers 22 are in their locked positions, the tumblers 22 project radially outwardly from the cylinder 18 and at least partially extend into the channel 34 to engage the housing 14. The tumblers 22 thereby prevent the cylinder 18 from rotating with respect to the housing 14 while the tumblers 22 engage the housing 14.

The cylinder 18 can have any cross-sectional shape desired, and in the illustrated embodiment has a generally round cross-sectional shape with a slot end 38 and a latch end 42. A slot 46 extends into the cylinder 18 in an axial direction from the slot end 38. The tumblers 22 are at least partially disposed within the slot 46. A properly-coded key 50 can be inserted into the slot 46 to actuate the tumblers 22 from their locked positions to their unlocked positions to disengage the tumblers 22 from the housing 14. The tumblers 22 can have any shape desired, a surface of which contacts the key 50 inserted into the slot 46 to move the tumblers 22 as just described. For example, the tumblers 22 can be L-shaped (with the key 50 riding upon a surface of either leg of the L-shaped tumbler 22), U-shaped, pin or post-shaped, bar-shaped, and the like. The tumblers 22 in the illustrated exemplary embodiment have an elongated 0 shape in which the key 50 rides upon an internal surface of the O-shaped tumblers 22. In particular, each tumbler 22 includes an aperture 54 located in the tumbler 22 to be at least partially aligned with the slot 46. The key 50 can include any coded surface desired, such as a plurality of grooves and ridges that actuate the tumblers 22 upon insertion of the key 50 into the slot 46. In the illustrated embodiment, as a properly-coded key 50 is inserted into the cylinder 18, the key 50 passes through the apertures 54 of the tumblers 22 and actuates the tumblers 22 against the biasing force of the springs 26 from the locked positions to the unlocked positions to disengage the tumblers 22 from the housing 14. The key 50 thereby retracts the tumblers 22 toward the cylinder 18 and out of the channel 34.

With continued reference to the embodiment of the present invention illustrated in FIG. 1, once the tumblers 22 are disengaged from the housing 14, the cylinder 18 can rotate with respect to the housing 14. The latch end 42 of the cylinder 18 can be directly or indirectly connected to a latch that selectively locks or unlocks a closure member (door, body portion, etc.). Rotation of the cylinder 18 can cause the latch to lock or unlock the closure member in a manner well-known to those skilled in the art.

The embodiment shown in FIG. 1 illustrates just one possible construction of a tumbler lock embodying the present invention. The principles of the present invention can be employed in any tumbler lock having any design. By way of example only, the principles of the present invention can be employed in any tumbler lock regardless of what lock element the tumblers move or engage (e.g., tumbler engagement with the housing, tumbler movement of a sidebar or other element, etc.); regardless of the shape or size of the tumblers; and regardless of the number of tumblers employed in the lock. Additionally, the lock design can have other shapes and structures for the housing and cylinder. The present invention is applicable to any lock employing one or more tumblers movable by a key.

The lock mechanism 10 can be used for security purposes to selectively permit access through any lockable member (e.g., into a vehicle through a door or other closure member). As mentioned above, the tumblers 22 in the illustrated exemplary embodiment extend into the channel 34 to engage the housing 14 and restrict rotation of the cylinder 18 with respect to the housing 14 while the tumblers 22 are in their locked positions. Therefore, it is desirable to employ tumblers 22 having material properties sufficient to withstand torsional forces and restrict rotation of the cylinder 18 when a properly coded key 50 is not inserted into the cylinder 18.

Some material properties for the tumblers 22 that can impact the ability of the lock assembly 10 to properly function include tensile strength, ultimate shearing strength, and hardness. The tumblers 22 should typically have an acceptable tensile strength and shear strength to withstand loads placed on the tumblers 22. It is generally desirable for the material of the tumbler 22 to be relatively strong to prevent forced rotation of the cylinder 18, but not too brittle that it will fail under stress. The hardness of the tumblers 22 can also be important. The key 50 contacts the tumblers 22 when the key 50 is inserted into the cylinder 18. Therefore, it is often desirable for the tumblers 22 to have a hardness that is substantially similar to the hardness of the key 50 to avoid excessive wear of either the tumblers 22 or the key 50 during the life of the lock 10. Hardness of the tumblers 22 can also be an important consideration during the manufacture of the tumblers 22.

As discussed above, some prior art lock mechanisms include tumblers made from brass, a key made from brass, and a cylinder made from zinc. Brass has a tensile strength of approximately 80 ksi, a shear strength of approximately 50 ksi, and a Rockwell B hardness of approximately 81-86. Brass is often used for tumblers because these material properties are desirable for the design considerations (discussed above) of tumblers. However, the combination of brass tumblers and a zinc cylinder is susceptible to galvanic corrosion.

Galvanic corrosion occurs when two dissimilar metals contact one another, with one metal acting as an anode and the other metal acting as a cathode. Electrons are transferred from the anode to the cathode, altering the two materials. The rate of corrosion depends at least partially on the total contact surface area between the two metals and how different the two metals are from each other in terms of galvanic activity. In the case of tumbler locks, the tumblers 22 of one material (brass) are at least partially disposed within the cylinder 18 of another material (zinc), and contact the cylinder 18.

Table 1 illustrates a partial galvanic table listing selected materials from anodic (or more active) to cathodic (or less active). Materials that are the farthest away from each other on Table 1 are the materials that will have the greatest reaction when in contact. As shown in Table 1, zinc and brass are relatively dissimilar materials and are relatively far apart from each other on the table. Galvanic corrosion takes place in some conventional lock assemblies by contact between brass tumblers and the zinc cylinder due to the differences between zinc and brass.

Corrosion, either galvanic or oxidation, generally affects the properties of the tumbler lock materials, and can cause the locks to seize and fail, or to otherwise not function properly. Corrosion can also weaken tumbler lock parts, affecting the tensile strength and shearing strength of such parts, and eventually leading to lock failure. If the lock seizes or fails, it may no longer be able to selectively lock or unlock the closure member.

TABLE 1
GALVANIC SERIES

Anodic (More Active)
Magnesium
Zinc
Aluminum 7075-T6
Aluminum 7178-T6
Steel 1010
Brass, Yellow, 268
Brass, Naval, 464
Yellow Brass
Brass (plated)
Red Brass
Stainless Steel
Cathodic (Less Active)

In the illustrated embodiment of FIG. 1, the cylinder 18 in the lock mechanism 10 is made from a first material that is more anodic than brass, while the tumblers 22 are made from a second material that is more anodic than brass, but less anodic than the first material. In some embodiments, the cylinder 18 is comprised of zinc, while the tumblers 22 are comprised of a material having a hardness substantially similar to the hardness of the key 50 (e.g., both being between about 75 and 95 Rockwell Hardness or both being within a 20 Rockwell Hardness range) to help prevent excessive wear on either the tumbler 22 or the key 50. A tumbler material having a Rockwell B hardness of between about 75 and about 95 can be employed for this purpose.

While other materials can instead be used, the material of the tumblers 22 in the illustrated exemplary embodiment is aluminum. As shown in Table 1, aluminum and zinc are not as far apart from each other in the galvanic series as brass and zinc, and aluminum is more anodic than brass. Therefore, corrosion is less likely to occur between aluminum and zinc than between brass and zinc. Even though aluminum is more active than brass, aluminum is closer to zinc in the galvanic series, so aluminum and zinc are more similar and galvanic corrosion can be reduced.

Taken alone, aluminum can be more subject to corrosion than brass. For example, aluminum is more galvanically active than brass and is generally more susceptible to oxidation than brass. Therefore, although the use of aluminum for the tumblers 22 is not an obvious choice in light of conventional wisdom (in which the objective is to reduce corrosion in the lock), the inventor has discovered that the combination of aluminum tumblers 22 and a zinc cylinder 18 in the present invention is less susceptible to corrosion than the prior art combination of zinc and brass.

While several materials, including aluminum, can be used for the tumblers 22, it is also desirable for the tumbler material to have an acceptable hardness. Some types of aluminum do not fall within a Rockwell B hardness between about 75 and about 95. However, aluminum alloy 7075-T6 is an example of a type of aluminum that does fall within this desirable range. In some embodiments, the tumblers 22 are made from heat treated aluminum alloy 7075-T6. As shown in Table 2, heat treated aluminum 7075-T6 has a tensile strength of approximately 83 ksi, an ultimate shearing strength of approximately 48 ksi, and a Rockwell B hardness of approximately 88. In some embodiments, heat treated aluminum 7075-T6 provides superior performance results, and can also be purchased in strip form (convenient for many manufacturing processes).

TABLE 2

| | | | Ultimate | |
|---|---|---|---|---|
| | | Tensile | Shearing | |
| | Density | Strength | Strength | Hardness |
| Material | (lb/in³) | (ksi) | (ksi) | (Rockwell B) |
| Brass | 0.308 | 81 | 50 | 81 |
| Aluminum | 0.096 | 83 | 48 | 88 |
| 7075-T6 (H.TR) | | | | |

While the hardness of the aluminum tumblers 22 can be slightly more than that of brass, it is still within an acceptable range that is close enough (substantially similar to) to the hardness of keys 50 (such as between about 75 and about 95 as discussed above or otherwise both within a 20 Rockwell Hardness range), thereby preventing excessive wear on the keys 50.

Several tests were conducted on a lock assembly 10 having aluminum tumblers 22 simulating actual wear conditions and exposure to elements commonly experienced by lock assemblies 10. The tests showed that the lock assemblies 10 of the present invention having aluminum tumblers 22 outperformed and outlasted conventional lock assemblies having brass tumblers. These results were unexpected since aluminum is considered to be more susceptible to corrosion than brass. Even more unexpected was the extent to which the aluminum tumblers 22 outperformed conventional brass tumblers. The aluminum tumblers 22 lasted approximately 3.3 times longer than conventional brass tumblers during the tests. Therefore, locks 10 having aluminum tumblers 22 have an operating life much longer than conventional locks having brass tumblers.

In addition to lasting longer before failure, tests conducted on the lock assembly 10 just described showed that the lock assembly 10 also performed better than conventional locks during the life of the locks. The tests measured key insertion, rotation, and extraction efforts for the lock assembly 10 after corrosion testing, but before failure of the lock assembly 10. The key insertion, rotation, and extraction efforts for the lock assemblies 10 having aluminum tumblers 22 were significantly reduced from the efforts required for conventional locks. Therefore, the lock assembly 10 of the present invention lasts longer than conventional locks, and also operates more smoothly than conventional locks over the useful life of the lock assembly 10.

In addition to the unexpected results obtained by the tumblers 22 and cylinder 18 of the present invention, other advantages are realized. For example, brass used for conventional tumblers has a density of approximately 0.308 lb/in³ as shown in Table 2. In some embodiments of the present invention, the tumblers 22 are made from a material having a density less than 0.2 lb/in³ to help reduce the weight of the tumblers 22. As shown in Table 2, aluminum has a density of approximately 0.096 lb/in³. Therefore, the aluminum tumblers 22 of the present invention weigh less than the conventional brass tumblers, resulting in a reduction of the overall weight of the lock assembly 10.

As another example, by employing aluminum tumblers 22, the tumblers 22 do not need to be plated or coated with an additional material to add certain material properties. Some conventional tumblers are plated with additional materials to alter the hardness, strength or corrosive resistance of the tumblers. Plating the tumblers adds an additional step to the manufacture of the tumblers, and also adds additional costs. Plated tumblers can also weigh more than unplated tumblers. The use of aluminum tumblers 22 according to the principles of the present invention can satisfy material property requirements needed by lock assembly manufacturers without additional plating. Alternatively, the tumblers 22 may be plated to provide additional features, if desired. However, plating is not necessary to provide tumblers 22 that are more anodic than brass and that have a Rockwell B hardness of between about 75 and about 95 as found in some embodiments of the present invention.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

1. A lock, comprising:
a housing;
a lock cylinder comprising a first material that is more anodic than brass;
a tumbler at least partially received within the lock cylinder and comprising a second material more anodic than brass but less anodic than the first material, and having a Rockwell B hardness between 75 and 95, the tumbler movable with respect to the housing between a first position in which the tumbler restricts rotation of the lock cylinder with respect to the housing and a second position in which the lock cylinder is rotatable with respect to the housing.

2. The lock of claim 1, wherein the second material has a Rockwell B hardness substantially similar to brass.

3. The lock of claim 1, wherein the second material is non-ferrous.

4. The lock of claim 1, wherein the second material has a density less than steel.

5. The lock of claim 1, wherein the second material has a density less than 0.2 lb/in³.

6. The lock of claim 1, wherein the second material is aluminum.

7. The lock of claim 6, wherein the second material is aluminum 7075-T6.

8. The lock of claim 1, further comprising a key insertable into the lock cylinder to actuate the tumbler between the first position and second position, the tumbler and the key member having a substantially similar hardness.

9. A lock comprising:
a housing;
a lock cylinder at least partially received within the housing; and
a tumbler comprising aluminum material, the tumbler movable with respect to at least one of the housing and the lock cylinder to selectively limit rotation of the lock cylinder with respect to the housing.

10. The lock of claim 9, wherein the tumbler has a Rockwell B hardness of between 75 and 95.

11. The lock of claim 9, wherein the tumbler has a Rockwell B hardness substantially similar to brass.

12. The lock of claim 9, wherein the tumbler comprises aluminum 7075-T6 material.

13. The lock of claim 9, further comprising a key insertable into the lock cylinder to actuate the tumbler, the tumbler and the key member having a substantially similar hardness.

14. A lock tumbler for use in a lock having a housing, a lock cylinder, and a tumbler spring, the lock tumbler comprising:
a tumbler body comprising aluminum material;
a first end shaped to releasably engage at least one of an interior surface of the housing and a sidebar; and
a second end adapted to be received within the lock cylinder.

15. The lock tumbler of claim 14, wherein the tumbler comprises aluminum material having a Rockwell B hardness between 75 and 95.

16. The lock tumbler of claim 14, wherein the tumbler comprises aluminum material having a Rockwell B hardness substantially similar to brass.

17. The lock tumbler of claim 16, wherein the tumbler comprises aluminum 7075-T6 material.

18. A method of manufacturing a lock, comprising:
forming a tumbler from a piece of material comprising aluminum;
coupling the tumbler to a lock cylinder; and
inserting the lock cylinder into a housing, the lock cylinder rotatable with respect to the housing in a first tumbler position and restricted from rotation to an unlocked position with respect to the housing in a second tumbler position.

19. The method of claim 18, further comprising hardening the aluminum tumbler to a Rockwell B hardness between 75 and 95.
